(19) United States
(12) Patent Application Publication
(10) Pub. No.: US 2010/0019595 A1
(43) Pub. Date: Jan. 28, 2010

(54) Onboard energy

(76) Inventor: Bailey Gifford Penn, Martinsville, VA (US)

Correspondence Address: Bailey G. Penn, 1109 Chatham Rd., Martinsville, VA, 24112, US

(21) Appl. No.: 12/460,215

(22) Filed: Jul. 15, 2009

Related U.S. Application Data
(60) Provisional application No. 61/135,692, filed on Jul. 23, 2008.

(51) Int. Cl. H02K 47/00; H02K 53/00

(52) U.S. Cl. 310/113; 415/916

(57) ABSTRACT

A working electrical system that transfers electricity from a generator through various components back to itself to produce a continuing cycle of electrical current.

This idea is to take a generator and use it to power automobiles by using “reverse energy.”

The energy form the generator could be converted back to itself to perform its task, therefore creating “on board energy.”

To start the process or motion, a battery and a starter could be used with other components to start the process of the generator producing the necessary energy to power the power train and all electrical functions for the vehicle as well.

The process in which the parts and all necessary components are made would be by molds and casting and necessary processes for building mechanical parts.

This application is based on a U.S. provisional application number 61/135,692 filed Jul. 23, 2008 entitled Onboard Energy.

### FIELD OF IDEA

This idea relates to the field of electricity and the process of making it to produce electrical power for energy.

### BACKGROUND OF THE INVENTION

Electricity was led in study by Benjamin Franklin an inventor, until the time of Thomas A. Edison. Since thin many ideas has come forth from the discovery of electricity including the idea of generators which produce this energy.

Generators produce electricity for a host of useful things in the lives of mankind such as lights heat transportation and helps in the use of many useful devices in the world.

### SUMMARY

Since the invention of electricity, it has been a very helpful source of energy in the lives of mankind and have had great innovations for our population. So the process of using a reverse process to power automobiles would be a helpful and needful process today.

1. The process of using a generator to produce its own energy through a reverse: process can supply the necessary current to power automobiles, replacing the need for fossil fuel and making it an alternative power source.

2. Furthermore in claim 1 reversing the energy through necessary components to generate energy needed to operate a motor to turn the generator would in fact create on board energy hopefully cutting back on greenhouse gases and global warming.

3. All components output would be according to the need for each particular vehicles needs for its performance.

4. As for claim 3 the need for certain components will vary according to the need of said equipment.
